(19) United States
(12) Patent Application Publication
(10) Pub. No.: US 2014/0322027 A1
(43) Pub. Date: Oct. 30, 2014

(54) WIND TURBINE ROTOR BLADE AND A METHOD FOR DEICING A WIND TURBINE ROTOR BLADE

(71) Applicant: Wobben Properties GmbH, Aurich (DE)

(72) Inventor: Gerhard Lenschow, Aurich (DE)

(73) Assignee: Wobben Properties GmbH, Aurich (DE)

(21) Appl. No.: 14/358,997

(22) PCT Filed: Nov. 16, 2012
(86) PCT No.: PCT/EP2012/072822

§ 371 Date: May 16, 2014

(30) Foreign Application Priority Data
Nov. 17, 2011 (DE) 10 2011 086 603.5

(51) Int. Cl. F03D 11/00

(52) U.S. Cl. CPC F03D 11/0025
USPC 416/96 R

(57) ABSTRACT

There is provided a wind power installation rotor blade comprising a rotor blade nose, a rotor blade trailing edge, a rotor blade root region for fixing the rotor blade to a hub of a wind power installation and a rotor blade tip. The rotor blade extends from the rotor blade root region along a longitudinal axis to the rotor blade tip. The rotor blade further has an air distribution unit having an adjusting member for directing an air flow into the rotor blade nose region and/or a rotor blade trailing edge region.

### BACKGROUND

1. Technical Field

The present invention concerns a wind power installation rotor blade and a method of de-icing a wind power installation rotor blade.

2. Description of the Related Art

Wind power installations are increasingly also being set up in areas in which icing of the rotor blades of the wind power installation can occur. Icing of the rotor blades of the wind power installation is not only dangerous but also reduces the output yield of the wind power installation. Therefore many methods of early detection of icing of a rotor blade and de-icing a rotor blade are known. Icing of the rotor blade can be reduced or alleviating by heating the rotor blade.

A reduction in output yield occurs upon icing of a rotor blade, in particular in the nose region (that is to say the leading edge region of the rotor blade). Many methods of de-icing the nose region of the rotor blades of wind power installations have therefore been proposed.

The German Patent and Trade Mark Office has searched the following documents in the priority application in respect of the present application: DE 10 2010 051 296 A1; DE 10 2010 051 297 A1; DE 10 2010 051 293 A1; DE 10 2010 030 472 A1; DE 10 2005 034 131 A1; DE 195 28 862 Al and DE 200 14 238 U1.

### BRIEF SUMMARY

One or more embodiments of the present invention is to provide a wind power installation rotor blade and a method of de-icing a wind power installation rotor blade.

One embodiment is directed to a wind power installation rotor blade according to claim 1 and anther embodiment is directed to a method of de-icing a wind power installation rotor blade according to claim 9.

Thus there is provided a wind power installation rotor blade comprising a rotor blade nose, a rotor blade trailing edge, a rotor blade root region for fixing the rotor blade to a hub of a wind power installation and a rotor blade tip. The rotor blade extends from the rotor blade root region along a longitudinal direction to the rotor blade tip. The rotor blade further has an air distribution unit having an adjusting member for directing an air flow into the rotor blade nose region and/or a rotor blade trailing edge region.

In an aspect of the present invention in a first operating mode the air distribution unit is of such a configuration that an air flow is directed into the rotor blade nose region. In a second operating mode the air distribution unit is of such a configuration that an air flow is directed at least partially into the rotor blade trailing edge region. By means of the adjusting member, the air distribution unit can direct the air flow either to the rotor blade nose region or to the rotor blade trailing edge region, whereby specifically targeted de-icing of the rotor blade or parts thereof is possible.

In a further aspect of the invention there is provided at least one first bar or spar along the longitudinal direction of the rotor blade from the rotor blade root region to the rotor blade tip. The interior of the rotor blade is divided by the at least one bar into different volumes which are separately heatable.

In a further aspect of the present invention the at least one bar is of such a configuration in the region of the rotor blade tip that an air flow in the rotor blade nose region is guided back along the at least one first bar or between a first and a second bar to the rotor blade root region.

Optionally there can be provided a closable opening for the first and/or second bar in the region of the rotor blade tip so that, when the opening is open, the air flow can flow through the trailing edge region back to the rotor blade root region and can thus heat the trailing edge region.

As an alternative thereto, there can also be provided closable openings in the rotor blade root region to permit an air flow in a volume between a first and a second bar or in a volume between a first bar and the trailing edge region.

In a further aspect of the present invention the air distribution unit has a first portion for receiving a heated air flow, a second portion for directing the heated air flow into the region of the rotor blade trailing edge and a third portion for directing the heated air flow into the rotor blade nose region.

In a further aspect of the invention the rotor blade is intended for a wind power installation with at least one megawatt.

Another embodiment also concerns a method of de-icing a wind power installation rotor blade. The wind power installation rotor blade has a rotor blade nose region, a rotor blade trailing edge, a rotor blade tip and a rotor blade root region. In a first operating mode a heated air flow is directed into the rotor blade nose region, and in a second operating mode a heated air flow is directed at least partially into the rotor blade trailing edge region of the wind power installation.

One embodiment also concerns a wind power installation having a rotor blade as described hereinbefore.

One or more embodiments concerns the idea of not only reducing or avoiding icing in the nose region of the rotor blade but also icing of the trailing edge region to improve operation of the wind power installation. In particular icing of the rotor blades over the entire surface area, that is to also of the rotor blade trailing edge, can lead to a detrimental effect on operation of the installation. Even if for example the hub region is heated by a rotor blade heating system to such an extent that there is no longer any icing there, it may nonetheless be the case that there is still icing in the region of the rotor blade rear box section or the trailing edge region. Because of the large surface area of the rotor blade rear box section or the trailing edge region, particularly in the case of very large installations (involving a rated power output of >1 MW, icing can thus involve overall a considerable degree so that there is an unbalance in the rotor blades because of the coating of ice. That is noticeable in particular in the lower wind speed range as it is there that icing also on the trailing edge has a noticeably adverse effect.

Thus one or more embodiments concern the idea of heating not just the nose region of the rotor blade but also the trailing edge region thereof to avoid icing. That is particularly important in relation to wind power installations of the multi-megawatt range (that is to say >1 megawatt).

It is to be pointed out that, by virtue of the large volume of the rotor blade rear box section or the trailing edge region for wind power installations in the multi-megawatt range, heating of the complete rotor blade is linked to very high cost levels.

Accordingly one embodiment of the invention concerns a wind power installation rotor blade in which warm or heated air is blown into the rotor blade and in particular along the nose region, for example by a fan. Optionally bars or spars can extend along the longitudinal direction of the rotor blade. In order to be able to also heat the trailing edge region of the rotor blade, there is provided an air guide or air distribution unit having an adjusting member which can guide the air flow in the nose region or only to the rotor blade trailing edge region. That is advantageous because it is possible to dispense with a separate fan and an additional heating radiator for blowing heated air through the trailing edge region. Heating of the trailing edge region can be implemented by adjustment of the adjusting member, when needed and as long as desired.

Further aspects of the present invention are subject-matter of the appendant claims.

### BRIEF DESCRIPTION OF THE SEVERAL VIEWS OF THE DRAWINGS

Advantages and embodiments by way of example are described in greater detail hereinafter with reference to the drawing.

FIG. 1 shows a diagrammatic view of a wind power installation rotor blade according to a first embodiment,

FIG. 2 shows a diagrammatic view of a wind power installation rotor blade according to a second embodiment, and

FIG. 3 shows a diagrammatic view of a wind power installation according to the invention.

### DETAILED DESCRIPTION

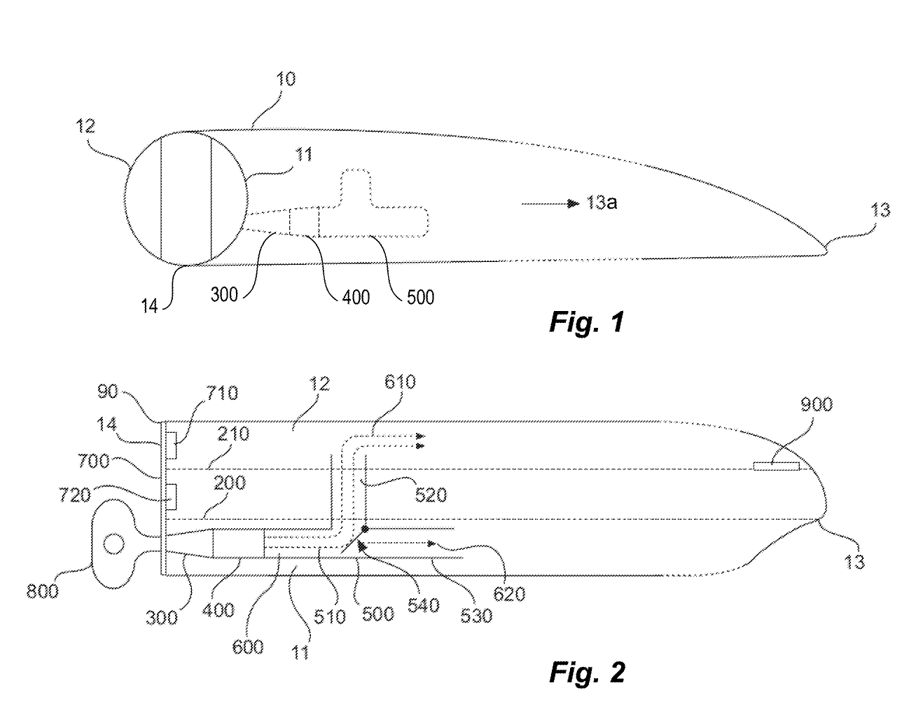

FIG. 1 shows a diagrammatic view of a wind power installation rotor blade according to one embodiment of the invention. The rotor blade 10 has a rotor blade nose region 11 and a rotor blade trailing edge region 12. The rotor blade 10 further has a rotor blade root region 14 and a rotor blade tip 13. In that arrangement the rotor blade 10 extends along its longitudinal direction 13a from the rotor blade root 14 to the rotor blade tip 13. Provided along the longitudinal direction 13a of the rotor blade are optionally one, two or more bars or spars 200, 210 which can extend at least partially along the longitudinal direction of an internal portion of the rotor blade as shown in FIG. 2. Optionally the first and second bars 210, 200 can be arranged substantially parallel to each other and between the pressure side and the suction side of the rotor blade. The internal volume of the rotor blade is divided into three volumes by the first and second bars 210, 200, namely a volume between the two bars, a volume between one bar and the rotor blade nose region and a third volume between one bar and the rotor blade trailing edge.

In addition the wind power installation rotor blade of the first embodiment has an air flow distribution or guide unit 500. Optionally the rotor blade can have a diffuser 300 and a heating radiator 400. A fan 600 can be connected to the diffuser 300, which fan can produce an air flow which can flow through the diffuser 300 and the heating radiator 400. In that case the air distribution unit 500 serves to guide the heated air flow either along the rotor blade nose region 11 or along the rotor blade trailing edge 12 to de-ice the rotor blade.

FIG. 2 shows a diagrammatic view of a wind power installation rotor blade according to a second embodiment. The rotor blade 10 has a rotor blade nose region 11, a rotor blade trailing edge 12, a rotor blade tip 13 and a rotor blade root region 14. The rotor blade can be connected to a hub 90 of a wind power installation by means of its rotor blade root region 14. The rotor blade 10 extends along its longitudinal direction from the rotor blade root region 14 to the rotor blade tip 13. The rotor blade has a rotor blade nose region 11 and a rotor blade trailing edge region or a rotor blade rear box region 12. Optionally a first and a second bar 200, 210 can be provided at least partially along the longitudinal direction of the rotor blade 10 so that the internal volume of the rotor blade can be divided into three volumes. The rotor blade root region 14 can be closed by a closing unit 700. In the rotor blade root region 14 the rotor blade can have a diffuser 300, a heating radiator 400, and an air flow distribution unit 500. The air flow distribution unit 500 can have a first portion 510 which can be coupled to the heating radiator 400. The air flow distribution unit 500 further has a second portion 520 and a third portion 530. The second portion 520 serves to direct the heated air flow into the region of the rotor blade trailing edge 12. The third portion 530 of the air flow distribution unit 500 serves to direct the heated air flow at least partially along the rotor blade nose 11. The air distribution unit 500 further has an adjusting member 540 which can open or close either the second or third portion 520, 530 so as to permit an air flow 610, 620 through the second and/or third portion 520, 530. As an alternative thereto the adjusting member can also be partly opened so that the air flow can flow into the nose region and also into the trailing edge region.

Optionally a fan 800 can be provided in the region of the rotor blade root 14 and can blow an air flow into the diffuser 300. The fan 800 can also be provided in the hub 90 of the wind power installation.

One embodiment of the invention is based on the notion of using already existing components for de-icing a rotor blade of a wind power installation, not just for de-icing the rotor blade nose region but also for de-icing the rotor blade trailing edge 12. That is effected in that the heated air flow can be directed by air distribution unit 500 not only into the rotor blade nose region 11 but also or only into the region of the rotor blade trailing edge.

In that way the control of the wind power installation can be used to also de-ice the rotor blade trailing edge or the region of the rotor blade trailing edge by means of a heated air flow. For that purpose only one air flow deflection unit or air distribution unit 500 with an adjusting member 540 is used. Control of the wind power installation, in a first operating mode, can pass a heated air flow into the rotor blade nose region 11. In a second operating mode the heated air flow can be passed by the air distribution unit into a region of the rotor blade trailing edge 12, instead of into the rotor blade nose region. In that way the trailing edge can also be heated and thus de-iced by switching over from the first into the second operating mode.

Thus the rotor blade trailing edge can also be de-iced when required by the control of the wind power installation. If de-icing of the rotor blade trailing edge is not required then the wind power installation control remains in the first operating mode and blows heated into the rotor blade nose region.

In the first operating mode therefore the adjusting member 540 in the air distribution unit 500 can assume a first position, that is to say the air flow through the second portion 520 is avoided and the entire air flow can flow through the third portion 530 along the rotor blade nose region to the rotor blade tip 13. Then the air flow can flow between the first and second bars 100, 200 into the rotor blade root region 14 again, so that this can produce a circuit. In that case the rotor blade rear box region can be separated from the heated air flow by the first bar 210 and the adjusting member 540 so that only the rotor blade nose region is heated. In that way the energy loss of the return flow of air is minimized and the maximum energy can be supplied in relation to the maximum surface area in the rotor blade nose region.

The adjusting member 540 can be set in the second operating mode in such a way that an air flow through the third portion 530 into the rotor blade nose region is avoided. In that way the air flow heated by the fan 800 and the heating radiator 400 can flow through the second portion 520 into the rear region in the direction of the rotor blade tip 13. Optionally perforations or openings can be provided in the bars in the region of the rotor blade tip so that the air flow can then flow back between the first and second bars 200, 210 to the rotor blade root region 14.

An embodiment of the present invention is advantageous as de-icing of a rotor blade can be substantially improved only by the addition of an air distribution unit. A fresh degree freedom can be added to the wind power installation control system by the adjusting member of the air distribution unit. The rotor blades are particularly suited to being used in areas which are at severe risk of icing. The entire rotor blade can be heated as required and successively by an air flow.

A rear box section can be provided at the rotor blade trailing edge in the region near the rotor blade root. Such a rear box section can be fitted as a separate component to the region of the trailing edge, that is near the rotor blade root. If the rear box structure is hollow then the rear box section can be heated in the second operating mode if the adjusting member of air distribution unit is so set that the heated air flows into the trailing edge region through the second portion 520.

In an aspect of the invention the rotor blade can optionally have a closable opening 900 in or at the first and/or second bar in the region of the rotor blade tip. An air flow 620 which extends along the rotor blade nose region can be directed through that closable opening into the volume between the first and second bars or into the volume the first bar 210 and the rotor blade trailing edge. If the closable opening 900 is opened then the air flow 620 can also flow through the volume between the first bar 220 and the rotor blade trailing edge 12 back into the rotor blade root region. Admittedly, the air flow which flows along the rotor blade trailing edge is already cooled down (as it has already flowed along the rotor blade nose region) but the air flow will nonetheless be able to contribute to heating the rotor blade trailing edge.

In a further aspect of the invention there can optionally be provided one or two closable openings 710, 720 in or at a closing unit 700 for closing the rotor blade root region of the rotor blade. Controlling opening or closing of the closable openings 710, 720 makes it possible to control whether the air flow flows from the rotor blade tip 13 through the volume between the first and second bars 210, 200 or through the volume between the first bar 210 and the rotor blade trailing edge. If the opening 710 is opened then the air flow can flow through the volume between the first bar 210 and the rotor blade trailing edge 12. If however the second opening 720 is opened then the air flow can flow back through the volume between the two bars.

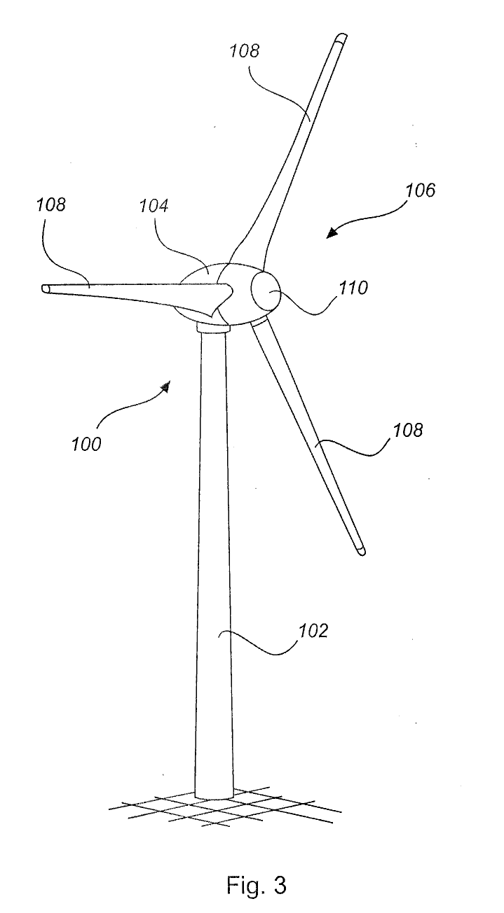

FIG. 3 shows a diagrammatic view of a wind power installation according to the invention. The wind power installation 100 has a pylon 102 and a pod 104. Arranged on the pod 104 is an aerodynamic rotor 106 having three rotor blades 108 and a spinner 110. In operation the rotor 106 is caused to rotate by the wind and thereby drives a generator in the pod 104. The rotor blades 108 can correspond to the rotor blades 10 of FIG. 1 and FIG. 2.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation rotor blade comprising;
a rotor blade nose region;
a rotor blade trailing edge region;
a rotor blade root region for fixing the rotor blade to a hub of a wind power installation;
a rotor blade tip region, wherein the rotor blade extends from the rotor blade root region along a longitudinal direction to the rotor blade tip region; and
an air distribution unit having an adjusting member for directing an air flow inside of the rotor blade to at least one of the rotor blade nose region and rotor blade trailing edge region.

2. The wind power installation rotor blade according to claim 1 wherein:
in a first operating mode, the air distribution unit directs the air flow to the rotor blade nose region; and
in a second operating mode, the air distribution unit directs the air flow at least partially to the rotor blade trailing edge region.

3. The wind power installation rotor blade according to claim 1 further comprising at least one first bar located in an interior of the rotor blade and extending along the longitudinal direction of the rotor blade from the rotor blade root region to the rotor blade tip region.

4. The wind power installation rotor blade according to claim 3, wherein the at least one first bar includes an opening in the rotor blade tip region so that an air flow in the rotor blade nose region is guided back along the at least one first bar to the rotor blade root region.

5. The wind power installation rotor blade according to claim 1 wherein, the air distribution unit has a first portion for receiving a heated air flow, a second portion for directing the heated air flow to the rotor blade trailing edge region and a third portion for directing the heated air flow into the rotor blade nose region.

6. A wind power installation comprising a wind power installation rotor blade according to claim 1, wherein the wind power installation has a rated power output of with at at least 1 MW.

7. A wind power installation rotor blade comprising;
a rotor blade nose region;
a rotor blade trailing edge region;
a rotor blade root region for fixing the rotor blade to a hub of a wind power installation;
a rotor blade tip region, wherein the rotor blade extends from the rotor blade root region along a longitudinal direction to the rotor blade tip region; and
a first bar in an interior of the rotor blade extending along the longitudinal direction of the rotor blade from the rotor blade root region to the rotor blade tip region, the first bar including a closable opening in the rotor blade tip region, wherein when the closable opening is opened, air travels from a first side of the first bar to a second side of the first bar.

8. A wind power installation rotor blade comprising:
a rotor blade nose;
a rotor blade trailing edge;
a rotor blade root region for fixing the rotor blade to a hub of a wind power installation;
a rotor blade tip, wherein the rotor blade extends from the rotor blade root region along a longitudinal direction to the rotor blade tip;
at least one first bar located inside of the rotor blade and extending along a longitudinal direction of the rotor blade; and
a closing unit located in the rotor blade root region, the closing unit having at least one closable opening, wherein air flows through the at least one closable opening when the closable opening is opened.

9. A method of de-icing a wind power installation rotor blade wherein the wind power installation rotor blade has a rotor blade nose region, a rotor blade trailing edge, a rotor blade tip and a rotor blade root region, the method comprising:
in a first operating mode: directing a heated air flow into the rotor blade nose region, and
in a second operating mode: directing a heated air flow at least partially into the rotor blade trailing edge region of the wind power installation.

10. A wind power installation comprising
a least one rotor blade according to 7, wherein the wind power installation has a rated power output of at least 1 MW.

11. The wind power installation rotor blade according to claim 7, wherein on the first side of the first bar is a first cavity proximate the rotor blade nose region and on the second side of the first bar is a second cavity proximate the rotor blade training edge region.

12. The wind power installation rotor blade according to claim 7, further comprising a second bar in the interior of the rotor blade extending along the longitudinal direction of the rotor blade from the rotor blade root region to the rotor blade tip region, the first bar forming a first cavity proximate the rotor blade nose region for air to flow therethrough, the second bar forming a second cavity proximate the rotor blade training edge region for air to flow therethrough.

13. The wind power installation rotor blade according to claim 12, wherein the closable opening permits air to flow from the first cavity to the second cavity.

14. The wind power installation rotor blade according to claim 12, further comprising an air distribution unit that includes an adjusting member configured to adjust the amount of air being provided to the second cavity.

15. The wind power installation rotor blade according to claim 8, further comprising an air distribution unit configured to direct air flow to at least one of the rotor blade nose and the rotor blade trailing edge.

16. The wind power installation rotor blade according to claim 15, further comprising a fan at an end of the air distribution unit that forces the air flow to the rotor blade nose and the rotor blade trailing edge.
